(19) United States
(12) Patent Application Publication
(10) Pub. No.: US 2017/0357254 A1
(43) Pub. Date: Dec. 14, 2017

(54) Parameter Setting Device

(71) Applicant: Futaba Corporation, Mobara-shi (JP)

(72) Inventor: Masahiro Tanaka, Mobara-shi (JP)

(21) Appl. No.: 15/618,255

(22) Filed: Jun. 9, 2017

(30) Foreign Application Priority Data
Jun. 10, 2016 (JP) 2016-116420

(51) Int. Cl. G05D 1/00; A63H 29/22; A63H 27/00; A63H 30/04

(52) U.S. Cl. CPC G05D 1/0011; A63H 30/04; A63H 29/22; A63H 27/02

(57) ABSTRACT

The parameter setting device has a parameter data input unit and a setting control unit which stores parameter data in an empty channel in the steering signal received from the transmitter and sends it to the transmitter. The parameter setting device and the transmitter are connected, and the parameter data is input to the parameter setting device. The parameter setting device stores the parameter data in the empty channel of the steering signal received from the transmitter and sends it back to the transmitter. The transmitter sends its steering signal to the body to be steered. The parameter data of the specific operation object mounted on the object to be steered can be reliably changed while continuing the operation of the operation object mounted on the object to be steered.

### BACKGROUND OF THE INVENTION

### Field of the Invention

The present invention relates to a parameter setting device attached to a transmitter for steering a remotely such as a moving body like a helicopter, an airplane, a car, a ship or an industrial operated machine unattendedly, and capable of reliably changing a parameter that defines the steering characteristics of an operation object mounted on the body to be steered, while continuing steering via the transmitter.

### Description of the Related Art

Japanese Unexamined Patent Publication No. 6-344995 discloses an invention of a remote control type unmanned helicopter. According to the invention, a flight control device 4 for generating a command signal for controlling an airframe 1 is configured so that hardware-like setting is unnecessary and various settings can be performed by software, and a data input/output portion and a data display device 7 having a data display unit are connected to the flight control device 4 so that various data signals such as various information required by a machine body 1 and data for software change can be input to the flight control device 4 through the data input/output portion of the output display device 7, and various data signals can be output from the flight control device 4 and displayed on the data display unit of the data input/output display device 7. Therefore, according to the invention, it is said to obtain the effects that without outputting laborious tasks such as disassembling the airframe it is possible to input various data signals from outside to an airframe system, and output various data signals from the airframe system so as to be displayed.

### SUMMARY OF THE INVENTION

### Technical Problem

According to the invention disclosed in Japanese Unexamined Patent Publication No. 6-344995, as shown in FIG. 4 and FIG. 6 of the same document, without setting the model body 1 to be disassembled, a setting device dedicated to the flight control device 4 in the body 1 (a personal computer 11, an external input/output device 8, etc.) is directly connected to these setting devices so as to operate them, and it is possible to change the setting of the flight control device 4 in the airframe. However, as is clear from the setting change state shown in FIG. 6, there was a problem that it is not possible to change the setting during operation of the model.

The present invention has been made to solve the above-described problems of the related art, and it is an object of the present invention to change certainly parameters defining steering characteristics of an operation object mounted on a body to be steered while continuing steering the control device by the transmitter.

### Solution to Problem

A parameter setting device according to a first aspect is connected to a transmitter corresponding to a plurality of operation objects mounted on a body to be steered and repeatedly transmitting one frame of a steering signal having a plurality of channels, each of the channels having a control data of the operation object stored therein, and setting a parameter data to the operation object, and includes: an input unit inputting the parameter data, and a setting control unit transmitting to the transmitter a setting signal in which the parameter data of the specific operation objects is stored in a predetermined channel.

A parameter setting device according to a second aspect of the present invention is connected to a transmitter corresponding to a plurality of operation objects mounted on a body to be steered and repeatedly transmitting one frame of a steering signal having a plurality of channels, each of the channels having a control data of the operation object stored therein, and setting a parameter data to the operation object, and includes: an input unit inputting the parameter data, and a setting control unit storing in an empty channel the parameter data of the specific operation object in the steering signal of one frame received from the transmitter, and sending it to the transmitter.

A parameter setting device according to a third aspect of the present invention is the parameter setting device according to the second aspect, the setting control unit stores in a first empty channel an identification data as the parameter data in the steering signal of one frame accepted from the transmitter, and in a second empty channel a characteristic data as the parameter data.

According to a parameter setting device of a fourth aspect, the transmitter in the parameter setting device according to the third aspect includes a plurality of specific operators assigned to each of the specific channels, stores a condition data of the specific operators in a specific channel assigned to the specific operator, and sends the one frame of the steering signal to the parameter setting device, wherein the setting control unit handles the parameter data and a corresponding data indicating a relationship with the parameter data and the condition data of the specific operator, and obtains the parameter data of the specific operation object based on the corresponding data and the condition data of the specific operator included in the one frame of the steering signal received.

### Advantages of the Invention

The parameter setting device as claimed in first aspect is brought into such a state as to communicate with a transmitter, and parameter data of the specific operation object mounted on the object to be steered is input from the input unit of the parameter setting device. The parameter setting device generates the setting signal in which the parameter data of the specific operation object is stored in the predetermined channel and sends the setting signal to the transmitter. The transmitter transmits the steering data which is the control data of the plurality of operation objects mounted on the object to be steered to each channel other than the specific channel among the channels of the setting signal sent from the parameter setting device, and transmits this to the object as the steering signal including parameter data and steering data. It is possible to reliably change the parameter data of the specific operation object mounted on the object to be steered while continuing the steering of the operation object mounted on the object to be steered.

The parameter setting device according to the second aspect is brought into such a state as to communicate with a transmitter, and parameter data of the specific operation object mounted on the body to be steered is input from the input unit of the parameter setting device. The parameter setting device stores the parameter data in the empty channel of the one frame of the steering signal received from the transmitter and sends back the parameter data to the transmitter. The transmitter transmits the steering signal including the parameter data and the steering data to the body to be steered. It is possible to reliably change the parameter data of the specific operation object mounted on the object to be steered while continuing the steering of the operation object mounted on the object to be steered.

Generally, many transmitters constituting a part of a wireless communication system for remote control have a function called a trainer function. This trainer function is a function in which a person who is familiar with remote control with a wireless communication system as a person to teach, that is, a teacher, and a student who is not proficient in this field, and two transmitters operated by a teacher and a student are prepared and connected with a cable or the like so that radio waves transmitted to the object to be steered can be switched by the transmitter on the teacher's side as necessary, thereby making it possible to assist and teach the steering skills.

According to the parameter setting device of the present invention, it is possible to use a trainer port which is the connection terminal provided in the transmitter for connection with the transmitter. Many types of transmitters with a trainer function provided with trainer ports are widely available on the market, including inexpensive products such as no display for displaying parameters or software for changing parameter settings. Therefore, according to the parameter setting device of the present invention, preparation of this allows many users who uses inexpensive version of the transmitter which cannot set or change the parameters by themselves to obtain a practically remarkable effect that parameters can be easily set.

According to the parameter setting device of the third aspect, in the one frame of the steering signal received from the transmitter, the identification data as the parameter data is stored in the first empty channel, the parameter data that is parameter data in the second channel, these parameter data can be sent to the transmitter in one frame of the steering signal simultaneously with the steering data, and the transmitter sends the steering signal of such data composition to the body to be steered. Therefore, firstly, the identification data and the characteristic of the parameter data can be transmitted simultaneously with the steering signal in one frame, so that it is possible to change the steering characteristic by changing the setting of the parameter during steering of the object to be steered. Next, since the characteristic data and the identification data of the parameter can be transmitted as a pair, it is possible to change the setting of the parameter included in the received steering signal if the signal of at least one frame is received, thereby inducing no inconvenience such that setting of parameters cannot be changed unless a plurality of frames are successively received, and enabling parameters of the equipment of the body to be steered to be reliably changed even in an environment where there are a plurality of transmitted radio waves in which frequency bands overlap.

According to the parameter setting device of the fourth aspect, if a specific operation to which a desired function is assigned out of the operators provided in the transmitter is selected and an appropriate operation is performed, the specific operation element is sent to the parameter setting device along with the steering signal. Since the parameter setting device has the correspondence data indicating the relationship between the parameter data and the state of the specific operation member, the parameter data of the specific operation object is acquired on the basis of the correspondence data and the condition data of the specific operation member included in the received one frame of the steering signal. The parameter setting device stores the parameter data (two empty channels in the case of identification data and characteristic data) in an empty channel of the one frame of the steering signal received from the transmitter, and sends back it to the transmitter. The transmitter transmits the steering signal including the parameter data and the steering data to the body to be steered. It is possible to reliably change the parameter data of the specific operation object mounted on the object to be steered while continuing the operation of the operation object mounted on the object to be steered. Therefore, even if it is temporarily difficult to directly operate the parameter setting device during the steering, the operation of the specific operators of the transmitter makes it possible to arbitrarily change or set the parameter data of the specific operation object of the object to be steered.

### BRIEF DESCRIPTION OF THE DRAWINGS

FIG. 1 is a front view of a transmitter and a parameter setting device according to a first embodiment;

FIG. 2 is a functional block diagram of the transmitter and the parameter setting device according to the first embodiment;

FIG. 3 is a diagram showing a basic data structure of a steering signal exchanged between the transmitter and the parameter setting device in the first embodiment:

FIG. 4 is a functional block diagram of a receiver in the first embodiment;

FIG. 5A is a schematic diagram showing the operation of the transmitter and the parameter setting device in the first embodiment and the transmission and reception of signals over time;

FIG. 5B is a modification of FIG. 5A;

FIG. 6 is an explanatory diagram of correspondence data showing a relationship between parameter data set in a parameter setting device of the second embodiment and a state of a specific operator;

FIG. 7 is a flowchart showing a specific operation to be sent from a transmitter to a parameter setting device in the third embodiment; and

FIG. 8 is an explanatory diagram of correspondence data showing a relationship between parameter data set in the parameter setting device and a state of a specific operator according to the third embodiment.

### DETAILED DESCRIPTION OF THE PREFERRED EMBODIMENTS

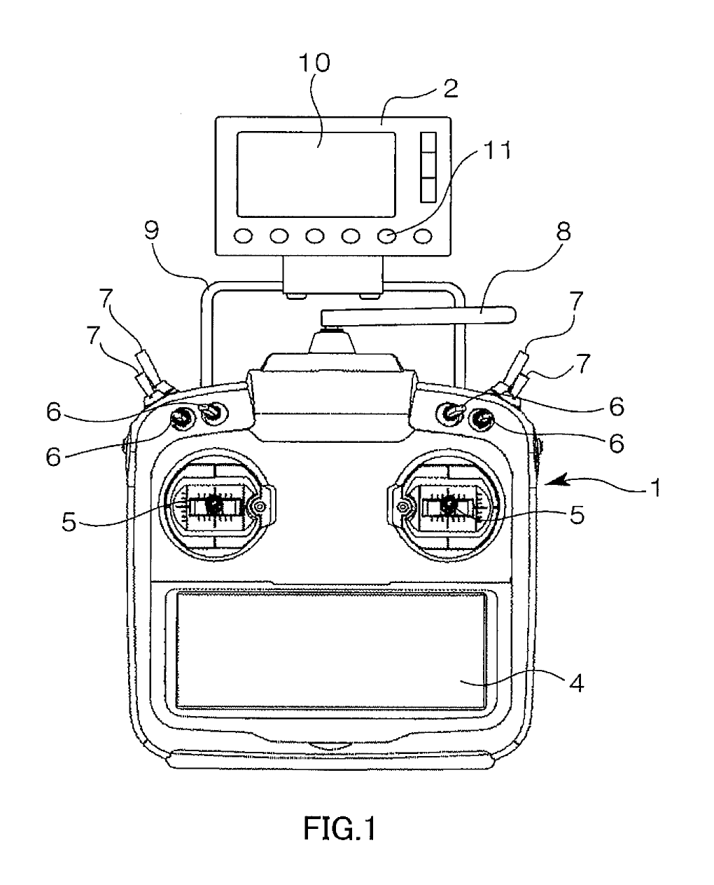

A communication system according to a first embodiment of the present invention will be described with reference to FIGS. 1 to 5. This communication system controls the steer of a model aircraft, which is a body to be steered. FIG. 1 is a front view schematically showing the external appearance of a transmitter 1 and a parameter setting device 2. The transmitter 1 is a main body having a substantially square shape in a front view as thin as the thickness in the paper surface direction compared with the lengthwise and breadthwise dimensions, a display portion 4 is provided in a lower portion of the front of the main body, and on the front upper portion thereof, two steering sticks 5, 5 for controlling the main steering operation of the model aircraft are arranged as operators. Furthermore, just above each sticks 5, two switches 6, 6 which are operators are provided respectively, and two switches 7, 7 which are operators are also provided near the left and right end portions of the upper surface of the housing respectively. Each of these switches 6 and 7 may be a 2-position switch that can be switched to two positions of ON/OFF, or a 3-position switch that can be switched to three upper, middle, lower positions. Although not shown in detail, the transmitter 1 is provided with a plurality of switches in addition to these, and a function for inputting various data necessary for steering the object to be steered is allocated to each of these switches.

As shown in FIG. 1, an antenna 8 is provided at the center of the upper surface of the casing of the transmitter 1, and can be bent at an arbitrary angle in an arbitrary direction via the hinge portion at the root. In the example of FIG. 1, it is bent in a horizontal state toward the right direction. A frame-shaped handle 9 (gripping portion) having three sides of a rectangle is attached to the upper surface of the casing of the transmitter 1, avoiding the position of the antenna. While the handle 9 is a useful part as a point as a handle which the user grasps in the case of carrying the transmitter 1 or the like and a nodule for connecting a suspension cord for assisting holding the transmitter 1 on the front side of the body for operating the stick 5 with both hands, etc., the parameter setting device 2 is attached here in the present embodiment.

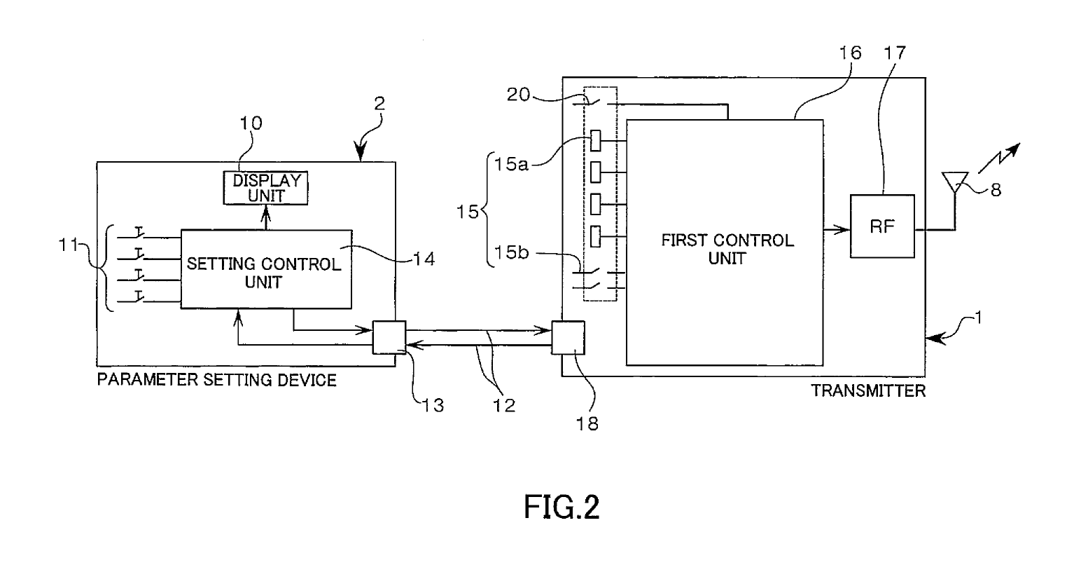

The parameter setting device 2, as will be described in detail later, which is a device for setting parameter data (identification data indicating the type thereof and characteristic data indicating the value thereof) to an operation object such as a gyroscope or an ESC (electric speed control unit) mounted on the body to be steered, includes a display unit 10 and an input unit 11 as shown in FIG. 1, and further a connection port 13 (not shown in FIG. 1) for connection with the transmitter 1 with the cable 12 and a setting control unit 14 (all shown in FIG. 2). In the embodiment, the parameter setting device 2 and the transmitter 1 can communicate with each other by connecting connection ports 13 and 18 with the cable 12, but this state is not shown in FIG. 1, and this state is also shown in FIG. 2 mentioned later.

FIG. 2 is a functional block diagram of the transmitter 1 and the parameter setting device 2 in the first embodiment. As shown in FIG. 2, the transmitter 1 has an input unit 15a first control unit 16, an RF unit 17, the above-described antenna 8, and the connection port 18.

The input unit 15 includes a first input unit 15a indicating the above-described stick 5 and the like, and a second input unit 15b indicating the above-described switches 6, 7 and the like. As other input means, an external device such as a parameter setting device 2 to be described later and a connection changeover switch 20 used when connecting to the second transmitter 1 are provided. The connection changeover switch 20 in the case of the transmitter 1 having the trainer function described above, may be referred to as a trainer switch or the like in some cases. There is no specific meaning to the number of the first input unit 15a and the second input unit 15b shown in FIG. 2, but this is merely a schematic example. Also, specific examples of the first input unit 15a and the second input unit 15b are not limited to only the stick 5 or the switches 2, 7 of the 2 or 3 position. Such volumes, dials, levers that can obtain continuous operation input are also included, and a change-over switch disconnecting other than 2 or 3 positions is also included.

In the input unit 15 having such a configuration, the driver steers the first input unit 15a and the second input unit 15b, whereby the steering data is generated by the first control unit 16 as will be described later, (Gyro 30, ESC, servo motors 31, 32, etc.) mounted on a body to be steered 25, which is to be described later. As will be described later, operating of the connection changeover switch 20 enables the transmitter 1 to communicate with the parameter setting device 2 connected via the connection port 18, which will be described later, and the parameter setting device 2, thereby receiving the parameter data from the parameter setting device 2 and transmitting the parameter data on the steering signal.

The first control unit 16 performs A/D conversion on the data of the position information input from the stick 5 of the first and second input units 15a, 15b, the switches 6, 7, etc., and then takes in by smoothing processing, computes the mixing and adjustment functions and converts them into the steering data that matches the servo operation signal. Here, the mixing and adjusting function means a function of reflecting the setting values etc. input from the switches 6, 7 etc. in the input unit 15 of the transmitter 1 on the signals of the stick 5 for steering and the like, including a function of fetching data input from an external device (such as a parameter setting device 2 described later) via the port 18. Then, the first control unit 16 adds header, ID, and error checking data to this steering data via a code converting circuit (not shown) as the steering signal of one frame, and iteratively generates this steering signal on a frame basis to generate an RF Section 17. The RF unit 17 modulates this data string and transmits it from the antenna 8 as a high frequency signal.

As described above, the one-frame steering signal transmitted by the transmitter 1 includes the header, the ID, the steering data, and the error checking data, but the steering data is segmented for each of a plurality of channels provided in one frame and stored. Here, by the channel is not meant a division of a different frequency band, but in the technical field of radio communication, different operation object that is generally an object to be controlled of the body to be steered, or a slot corresponding to each operation object in in the steering signal or an individual data stored in the slot, and the same applies to this specification. For example, assuming that the maximum number of channels that the transmitter can handle is N, the channel data is constructed by sequentially arranging individual control data (including control data) for each CH1 to CHN. The individual channel data has the same fixed-length bit number, and the control value or the like is indicated by the bit value.

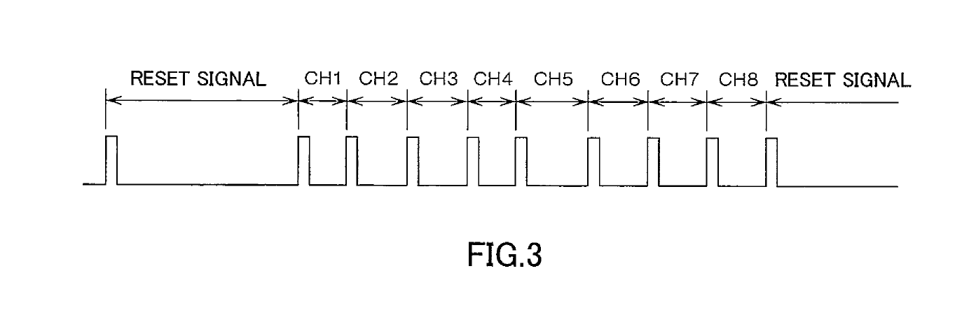

Further, when the connection change-over switch 20 of the input unit 15 is turned on, the first control unit 16 controls such as to transmit and receive a control signal to and from the parameter setting device 2 connected via the connection port 18. FIG. 3 illustrates a PPM (abbreviation of Pulse Position Modulation) waveform of the steering signal exchanged between the transmitter 1 and the parameter setting device 2. While the signal transmitted by the transmitter 1 from the antenna 8 is also referred to as the steering signal and includes the header, the ID, the steering data, and the error check data, the steering signal transmitted and received between the transmitter 1 and the parameter setting device 2, unlike this, is constituted only by the signal before adding the header, ID and error checking data to the first control unit 16, that is, a signal consisting essentially of the steering data. In the example of FIG. 3, one frame composed of channels 1 to 8 (CH 1 to CH 8) is used as a unit, and a reset signal for delimiting is placed between the frames.

The above-described connection port 18 is a data input/output terminal connected to an external device with a cable 12. In the present embodiment, as shown in FIG. 2, the parameter setting device 2 is connected to the connection port 18 via the cable 12, but this transmitter 1 can be connected with other transmitter to be used as a transmitter 1 having a so-called trainer function. That is, in the case of using the trainer function in this transmitter 1, another transmitter 1 operated by another pilot is prepared and the two transmitters 1, 1 are connected to communicate with the cable 12. Then, on the side of the one transmitter 1 to be a teacher, the connection changeover switch 20 is operated and a radio waves for steering the body to be steered 25 is switched between a radio wave from one transmitter 1 and a radio wave from the other transmitter 1 to be a student, a skilled pilot, becoming a teacher, can assist or teach the steering skill for a pilot who is not accustomed to steering.

In the present embodiment, since the parameter setting device 2 is attached to the transmitter 1 and is used, it is assumed that the transmitter 1 having no parameter setting function is targeted. That is, including inexpensive products such as no display for displaying parameter or parameter data, or no parameter setting change software installed, the transmitter 1 with a trainer function provided with a trainer port usable as the connection port 18 involves a fact that a large number of models are commercially available widely. Therefore, preparation of the parameter setting device 2 according to the present embodiment allows many users who are using inexpensive version of the transmitter which cannot set or change the parameter data alone to detect parameter data, thereby obtaining a practically remarkable effect that setting can be easily performed. In this embodiment, although as the connection port 18 of the transmitter 1 used to attach the parameter setting device 2 to the transmitter 1 and to set parameter data of a specific operation object, as described above, the trainer port in the transmission 1 with a trainer function is assumed, this is only one example, and the connection port 18 is not limited to the trainer port. That is, in the present invention, the connection port of the transmitter for attaching the parameter setting device may be such a connection terminal as to send the parameter data of the specific operation object set by the parameter setting device to the transmitter, and the original function of the connection terminal or the original purpose of providing the connection terminal in the transmitter does not matter.

Note that when connecting the parameter setting device 2 to the connection port 18 of the transmitter 1 and also when connecting the second transmitter 1 and using the trainer function, since the two devices connected with the cable 12 communicate bidirectionally, the cable 12 connecting the transmitter 1 and the parameter setting device 2 in the present embodiment is of a type capable of bidirectional communication.

As shown in FIG. 2, the parameter setting device 2 includes the input unit 11, the display unit 10, the connection port 13, and the setting control unit 14. The input unit 11, which is a unit for inputting parameter data respectively to be set to a plurality of operation objects mounted on the body to be steered 25, and is configured with various switches, dials, and the like. The display unit 10, when inputting parameter data via the input unit 11, can display the type of parameters indicated by the identification data, values indicated by the characteristic data, and the like. The connection port 13 is a data input/output terminal connected to an external device via the cable 12, and in FIG. 2, the transmitter 1 is connected to the connection port 13 via the cable 12.

The setting control unit 14 receives the control signal of one frame shown in FIG. 3 from the transmitter 1 via the cable 12 and the connection port 13, and thereafter the parameter data of the specific operation object input with the input unit 11 is stored in the empty channel of the steering signal of this one frame, and is sent back to the transmitter 1. For example, when the channel 7 (CH 7) and the channel 8 (CH 8) of the steering signal sent from the transmitter 1 to the parameter setting device 2 are empty channels, upon the steering signal being processed via the parameter setting device 2 to return to the transmitter 1, the identification data and the characteristic data of the parameter data input by the parameter setting device 2 are stored in the channel 7 (CH 7) and the channel 8 (CH 8) of the steering signal to be sent, respectively.

It is to be noted that by the operation object or device is here meant a device which is mounted on the object to be steered and can receive the signal sent from the outside and can control the object to be steered, in particular, change or set the parameter data set for adjusting, changing, or setting the control function. Also, a specific operation object arbitrarily designated by the driver to set/change parameter data is referred to as a specific operation object. Specific examples of devices will be described that is operation object or specific operation object and their parameters.

Examples of control parameters that can be changed in setting when the operation object or the specific operation object is an ESC, include a forward boost for setting a rising characteristic on the forward side from a neutral state, a current limiter for setting an output current limit value, a brake MAX duty for setting the brake strength between a neutral and the maximum points, a neutral brake for setting the neutral brake amount and the like.

In the case where the operation object or the specific operation object is a servo motor, it is also possible to change the setting of the control parameter data of the servo motor SM by connecting the necessary number of control lines L as described above. Examples of control parameters that can be changed in this case include a boost amount for setting the minimum operation amount to be applied to the internal motor when driving the servo, a damping gain for setting the characteristics when the servo is stopped, a stretcher gain for setting characteristics, and smoother which is a function for smoothing the movement of the servo.

Further, when the operation object or the specific operation object is a gyroscope used for a model airplane or the like, as a control parameter that can be changed in setting, for example, a control response for setting a delay of a ladder operation, a reaction in a tail operation AVCS response to adjust speed, pirouette feeling to select operation feeling during ladder operation, EXP for performing operation feeling setting near neutral of ladder stick, gain to set AVCS sensitivity, D gain for setting differential operation gain of gyro, D damping for setting the duration of gyro differentiation operation, and the like.

The steering data generated by the transmitter 1 is included in the steering signal sent from the transmitter 1, but the steering data generated by the transmitter 1 is not processed in the steering data but simply adding the identification data and the characteristic data of the parameter data to the two empty channels, and sends back to the transmitter 1. That is, the steering signal sent from the transmitter 1 is looped back to the transmitter 1.

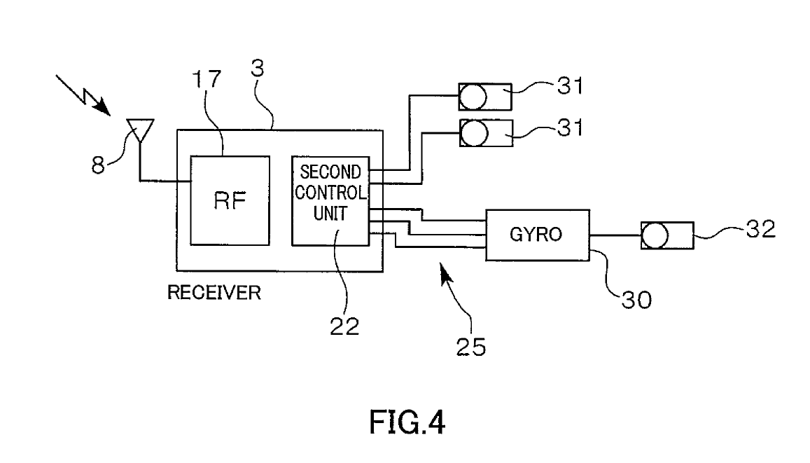

FIG. 4 shows an example of a system configuration of the receiver 3 included in the body to be steered 25. The receiver 3 shown in this figure has an antenna 8, an RF unit 17, and a second control unit 22. In addition, a plurality (two in the illustrated example) of servo motors 31 is connected to the second control unit 22 via a single control line, and each receives servo data from the second control unit 22 so as to be driven. In addition, a gyro 30 is connected as an operation object to the second control unit 22 with three control lines, and one gyro 30 is connected to one servo motor 32. The servomotor 32 connected to the gyro 30 does not have a control device or storage means, and cannot change its setting by itself. Therefore, it is the parameter of the gyro 30 that receives the setting change by the signal from the second control unit 22. For example, if the body to be steered 25 of the embodiment is an airplane, the servo motor 32 of the gyroscope 30 is provided for operating the steering mechanism.

Examples of a parameter whose setting of parameter data can be changed in the gyroscope 30 include a control response for setting the delay of the ladder operation, an AVCS response for adjusting the response speed of the tail operation, and pirouette feeling to select operation feeling during ladder operation, EXP for setting operation feeling near the neutral of the ladder stick, gain for setting the AVCS sensitivity, D gain for setting the differential action gain of the gyro, D damping for setting the duration of the gyro differential operation, etc.

The second control unit 22 is formed with, for example, a CPU or the like, and executes necessary control processing according to a program stored in the memory. In addition, the memory in this case is, for example, a part corresponding to the auxiliary storage device for the second control unit 22, and in addition to the above-mentioned program, various setting information and the like are stored.

Radio waves of the steering signal transmitted from the transmitter 1 are received by the antenna 8, and the received steering signal is demodulated by the RF unit 17. The second control unit 22 processes the demodulated signal, generates control data which is a PWM signal for each channel, that is, for each operation object, and outputs it to each operation object. The second control unit 22 controls the operation for each operation object such as the gyroscope 30 and the servomotor 31 based on the steering data for each channel. As a result, the object to be steered 25 performs an operation corresponding to the steering operation performed on the transmitter 1.

In addition, in the parameter setting device 2, when the setting change of the parameter data of the specific operation object is performed and the transmitter 1 includes the parameter data in the steering signal that has received the loop back from the parameter setting device 2, the second control unit 22 of the receiver 3 which received the steering signal from the transmitter 1 performs the following control. That is, the second control unit 22 of the receiver 3 performs appropriate processing after demodulating the digital signal received by the RF unit 17, the identification data and the characteristics data of the parameter data included in the first and second two channels (channel 7 (CH 7) and the channel 8 (CH 8)) are extracted, and supplies them to the gyro 30 as a PWM signal. As described above, the number of control lines connecting the second control unit 22 and the gyro 30 is three, and the identification data and the characteristic data are given to the gyro 30 via two of the control lines, and the setting of the parameter data is changed. Also, the control data of the servomotor 32 is given via the remaining one control line.

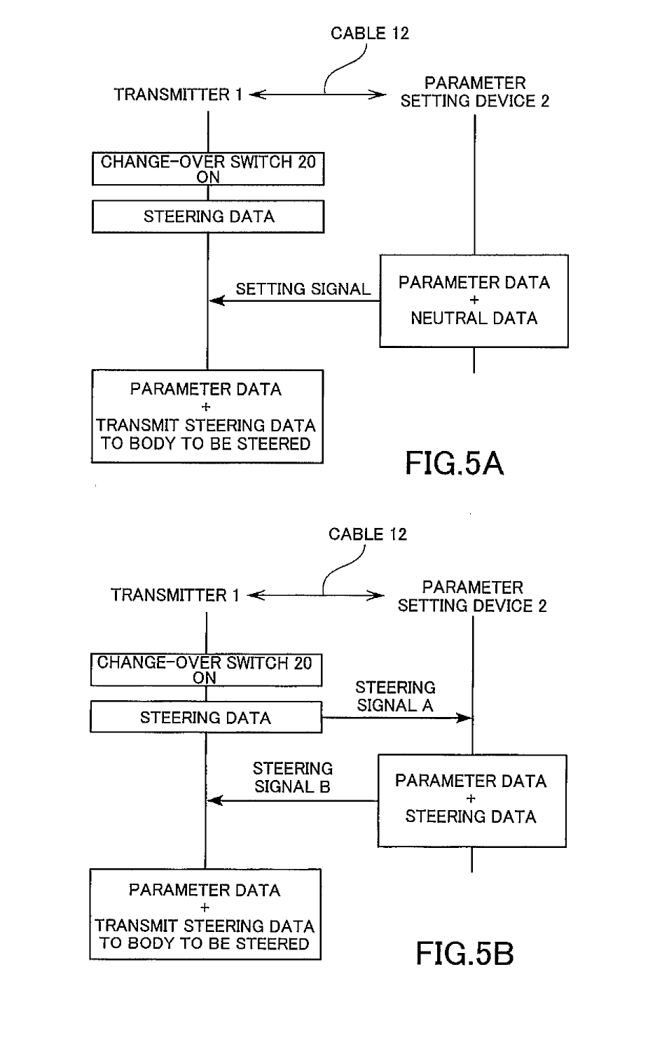

FIG. 5A and 5B are schematic diagrams showing the operation of the transmitter 1 and the parameter setting device 2 in the communication system of the present embodiment, in which FIG. 5A shows a main embodiment and FIG. 5B shows a modification. In FIGS. 5A and 5B, the operation of the transmitter 1 is shown on the left side, the operation of the parameter setting device 2 on the right side, and the flow of signals between them is indicated by arrows in the right and left direction. Also, the passage of time is shown to point from the upper side to the lower side. The operation of the communication system will be mainly explained with reference to the figure.

A main embodiment will be described with reference to FIG. 5A. This embodiment is a case in which the trainer function is ON and mutual communication between the transmitter 1 and the parameter setting device 2 is ON and the first mode among the plurality of modes of the trainer function is selected. This mode is used when the transmitter 1 has a function of adding the steering data on the side of the transmitter 1 to the signal sent from the parameter setting device 2 and transmitting it as a steering signal.

It is assumed that the transmitter 1 is powered on and that the pilot operates the transmitter 1 so as to operate the body to be steered 25. When the pilot operates the input unit 15 (for example, the stick 5 for steering), the first control unit 16 generates the steering data from the steering signal and transmits the steering signal including the steering data from the antenna 8. The receiver 3 of the object to be steered 25 receives this, the operation object is controlled, and the body to be steered 25 is steered. This operation is repeatedly performed at a predetermined cycle.

During steering, when the pilot closes the connection change-over switch 20 of the transmitter 1 as necessary (the connection changeover switch 20 is ON), mutual communication between the transmitter 1 and the parameter setting device 2 in the trainer function described above is established. When the pilot operates the input unit 11 while watching the display unit 10 of the parameter setting device 2 and inputs desired parameter data (identification data and characteristic data), the parameter setting device 2 generates inside a signal having the same structure as the steering signal the transmitter 1 generates, stores the identification data in the empty channel of the steering signal in the transmitter 1, for example, the channel corresponding to the channel 7 (CH 7), stores the characteristic data in the channel corresponding to the channel 8 (CH 8), the neutral data in the other channels, and transmits it to the transmitter 1 as the setting signal. As described above, the steer signal generated by the transmitter 1 is a PPM wave having a plurality of channels as shown in FIG. 3, so that the setting signal generated by the parameter setting device 2 is also the same. It is to be noted that by the neutral data generally is meant data indicating the midpoint of the entire movable range when the servo is to be operated.

The transmitter 1 adds the steering data to the setting signal received from the parameter setting device 2 to generate a steering signal. That is, the neutral data contained in each channel of the received setting signal is replaced by the corresponding data of the steering data, as the steering data to be transmitted, and it is transmitted to the body to be steered 25. As a result, the parameter data of the parameter designated by the pilot as the specific operation object of the body to be steered 25 is changed to the designated numerical value.

Since the parameter setting device 2 is attached to the handle 9 of the transmitter 1 and is located at a close distance from the finger of the pilot even when the pilot is in the steering operation, the input operation of the parameter setting device 2 is almost performed simultaneously with steering without some difficulty.

An embodiment according to the present invention will be described with reference to FIG. 5B. This embodiment is a case where the second mode among the plurality of modes possessed by the trainer function is selected in a state where mutual communication between the transmitter 1 and the parameter setting device 2 is ON, as ON in the trainer function. This mode is used when the transmitter 1 does not have the function of adding the steering data to the signal sent from the parameter setting device 2 and sending it as the steering signal.

It is assumed that the transmitter 1 is powered on and that the pilot operates the transmitter 1 to operate the body to be steered 25. When the pilot operates the input unit 15 (for example, the stick 5 for steering), the first control unit 16 generates the steering data from the steering signal and transmits the steering signal including the steering data from the antenna 8. The receiver 3 of the object to be steered 25 receives this, the operation object is controlled, and the body to be steered 25 is steered. This operation is repeatedly performed at a predetermined cycle.

During piloting, when the pilot closes the connection change-over switch 20 of the transmitter 1 as necessary (the connection changeover switch 20 is ON), mutual communication between the transmitter 1 and the parameter setting device 2 in the trainer function described above is established, and the steering signal A is sent from the transmitter 1 to the parameter setting device 2 via the cable 12. As described above, this steering signal is a PPM wave as shown in FIG. 3, and has substantially only steering data. Here, if the parameter data is not input in the parameter setting device 2, the control data of the steering signal A sent from the transmitter 1 to the parameter setting device 2 is looped back as it is to the aircraft 1 as the control data of the steering signal B, and is transmitted from the transmitter 1 to the object to be steered 25.

If the pilot operates the input unit 11 while watching the display unit 10 of the parameter setting device 2 and inputs desired parameter data (identification data and characteristic data), the parameter setting device 2, when receiving the steering signal A, stores the identification data in the empty channel of the steering signal A, for example, channel 7 (CH 7), stores the characteristic data in the channel 8 (CH 8), and transmits it to the transmitter 1 as the steering signal B. Also in this case, the steering data sent as part of the steering signal A from the transmitter 1 is looped back as it is to the transmitter 1 as part of the steering signal B.

The transmitter 1 transmits the steering signal B received from the parameter setting device 2 to the body to be steered 25. As a result, the parameter data of the parameter designated by the pilot as the specific operation object of the body to be steered 25 is changed to the designated numerical value. In this case, the control data B in which the identification data and the characteristic data of the parameter data and the steering signal are stored in one frame is transmitted as it is to the body to be steered 25, but it is arbitrary and it is not limited to this embodiment that the transmitter 1 transmits in what form and what kind of signal, the parameter data to the object to be steered 25.

According to the communication system of the present embodiment, when there are two or more empty channels not assigned to a specific operation object in the steering signal, setting of parameter data of a specific operation object desired by the pilot is continued while using the parameter setting device 2 attached to the transmitter 1. That is, when the pilot operates the input unit 11 while visually confirming the display on the display unit 10 of the parameter setting device 2, designates the parameter (type) of the specific operation object with the identification data, and inputs the set value (value) as data, the first control unit 16 of the transmitter 1 can transmit these parameter data to the body to be steered 25 simultaneously with the steering signal in one frame of the steering signal.

As described above, according to the communication system of the first embodiment, since the transmitter 1, even if not having the function of inputting parameter data, incorporates parameter data of a desired operation object into the steering signals to be transmitted to the object to be steered 25 by operating the parameter setting device 2 as far as the parameter setting device 2 is attached to the transmitter 1 and connected, it is possible to change the setting while steering the body to be steered 25.

Moreover, according to the parameter setting device 2, in each frame of the steering signal transmitted from the transmitter 1, the characteristic data and the identification data of the parameter data are stored in pairs in the two empty channels. Therefore, in the control data transmitted back to the transmitter 1 and transmitted from the transmitter 1, the characteristic data and the identification data of the parameter data are stored in sets for each frame. Therefore, if at least one frame of signal is received at the receiver 3, the setting of the parameter data included in the received steering signal can be changed. In the case of transmitting the identification data and the characteristic data in separate frames, the setting of the parameter data cannot be changed unless all of the frames are successively received, but in the present embodiment there is no such inconvenience, and the parameter data of the equipment of the body to be steered 25 can be reliably changed even in an environment a plurality of transmission radio waves is present of which frequency widths overlap to each other.

According to the connection configuration of the receiver 3 and the servomotor 31 etc. in the body to be steered 25 in FIG. 4, the servomotor 31 directly connected to the second control unit 22 of the receiver 3 cannot set and change the parameter data. However, some of the servomotors can be changed in settings, and if the servo motors 31 and 32 shown in FIG. 4 are servo motors of a type that can change the setting of parameter data, it is possible to change the setting of the parameter data by suitably connecting the second control unit 22 and the servo motor with three control lines.

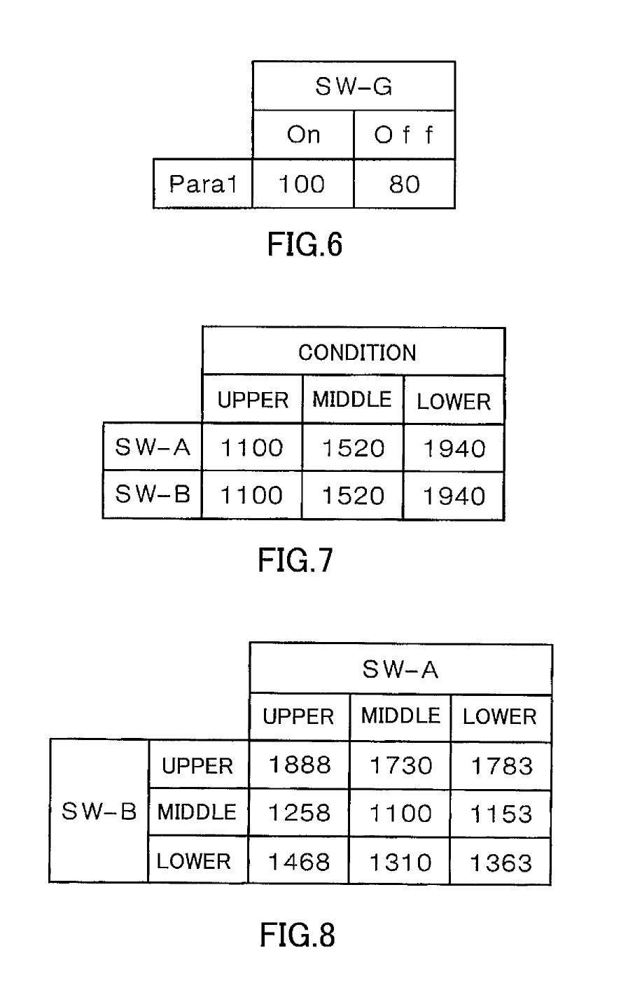

A communication system according to a second embodiment of the present invention will be described mainly with reference to FIG. 6. In the first embodiment, the parameter data is input via the parameter setting device 2 attached to the transmitter 1. In the present embodiment, the state in which the parameter setting device 2 is attached to the transmitter 1 and the parameter setting device 2 and the transmitter 1 are connected with the cable 12 is the same as the first embodiment, but it is characterized that the operation of change of setting of parameter data while steering can be performed at the operator (switch etc.) of the transmitter 1. The hardware configuration of the communication system of the first embodiment described with reference to FIGS. 1 to 4, the form of the steering signal and the like are cited in the present embodiment, but difference from the above-described first embodiment, as described below, is a difference in software (information processing method) in the setting control unit 14 of the parameter setting device 2.

In the first control unit 16 of the transmitter 1, a plurality of operators (switches etc.) is allocated to each channel. The steering signal A (see FIG. 5B) sent from the transmitter 1 to the parameter setting device 2 is a PPM waveform as shown in FIG. 3, but the condition data of the operator is stored in each channel corresponding to each operator.

For example, one of the switches 6 shown in FIG. 1 is considered as a switch SW-G which is an ON/OFF switch for changing setting of parameter data of the specific operation object of the body to be steered 25. In this case, due to the function of the first control unit 16 of the transmitter 1, data indicating the ON/OFF state of the switch SW-G is stored in the channel 5 (CH 5) of the steering signal A (see FIG. 5A, 5B) 1 and is transmitted from the first control unit 16 to the parameter setting device 2 (this also applies to the first embodiment). Therefore, in the parameter setting device 2, if the setting control unit 14 refers to the content of the channel 5 (CH 5) of the steering signal A, the state of the switch SW-G of the transmitter 1 can be grasped.

FIG. 6 is a table data stored in the parameter setting device 2, which is in the form of correspondence data expressing the relationship between the parameter data (100 or 80) of the switch SW-G and the state (On, Off) of the switch SW-G This corresponding data requires in advance input from the input unit 11 to the parameter setting device 2.

In FIG. 5A, 5B, in the steering signal A sent from the transmitter 1 to the parameter setting device 2, the condition data of the switch SW-G is stored in the channel 5 (CH 5) among the waveform shown in FIG. 3. When the parameter setting device 2 receives the steering signal A, the setting control unit 14 of the parameter setting device 2 confirms the data of the channel 5 (CH 5) of the steering signal A. Since the fact that the channel 5 (CH 5) corresponds to the switch SW-G is a matter preset in the setting control unit 14, the setting control unit 14 can be read from the data of the channel 5 (CH 5) that the state of the switch SW-G is ON or OFF. Then, the setting control unit 14 can acquire the type and value of the parameter data by using the read state (ON or OFF) of the SW-G and referring to the corresponding data shown in FIG. 6. For example, if the data of the channel 5 (CH 5) is ON, the type (identification data) of the parameter data is Para 1 from the corresponding data shown in FIG. 6, and its value (characteristic data) is 100. Note that this numerical value indicates the pulse width in each channel in the PPM signal as shown in FIG. 3.

The setting control unit 14 of the parameter setting device 2 stores the acquired identification data of the parameter data in the channel 7 (CH 7) of the steering signal shown in FIG. 3, stores the acquired characteristic data of the parameter data, and transmits this as a steering signal B from the parameter setting device 2 to the transmitter 1, as shown in FIG.

As described above, according to the communication system of the second embodiment, the transmitter 1 transmits the steering signal including the parameter data and the steering data to the object to be steered 25, and sends the steering signal including the parameter data and the steering data to the body to be steered 25, and while continuing the control and the operation of the operation object 25, the parameter data of the specific operation object mounted on the body to be steered 25 can be reliably changed. Therefore, even if it is temporarily difficult to directly operate the parameter setting device 2 during the steering, since it is easier to operate the specific operator of the transmitter 1, to change and set the specific operation object of the object 25 is made even more easily than in the first embodiment.

That is, the operator such as a switch, a lever, a dial and the like provided in the transmitter 1 is disposed at a sufficiently close position that the pilot can operate without departing from the stick 5 while the pilot steers the body to be steered 25. Therefore, the pilot can reasonably operate the controls such as switches, levers, dials and the like of the transmitter 1 while steering, and can set and change in real time the gyroscope 30 etc. mounted on the body to be steered 25.

A communication system according to a third embodiment of the present invention will be described mainly with reference to FIGS. 7 and 8. The parameter setting device 2 of the second embodiment described above reads the ON/OFF state of one switch of the transmitter 1 from the steering signal, and selects and acquires one of the two characteristic data in accordance with the ON/OFF state of the switch among corresponding data prepared beforehand. Although the basic idea is the same in the present embodiment, the present invention differs in reading the combination of the condition data of the plurality of switches of the transmitter 1, and selecting and acquiring one characteristics data from among the corresponding data prepared beforehand in accordance with combination of the state date.

FIG. 7 is an explanatory diagram of the condition data of the specific operator sent from the transmitter 1 to the parameter setting device 2. For example, the two switches 7 and 7 shown in FIG. 1 is considered as switches SW-A and SW-B which are three position switches that can be switched to three positions of upper, middle, and lower. It is assumed that these switches SW-A and SW-B change setting of parameter data of a specific operation object of the body to be steered 25. In this case, according to the function of the first control unit 16 of the transmitter 1, the data indicating up/down state of the switch SW-A is stored in the channel 5 (CH 5) of the steering signal A (see FIG. 5A, 5B), and each data indicating the upper and lower states of SW-B is stored in the channel 6 (CH 6) of the steering signal A (see FIG. 5) and sent to the parameter setting device 2 from the first control unit 16 of the transmitter 1 (This also applies to the first embodiment). Therefore, in the parameter setting device 2, when the setting control unit 14 refers to the contents of the channel 5 (CH 5) and the channel 6 (CH 6) of the steering signal A, the state of the switches SW-A and SW-B of the transmitter 1 can be grasped. It is to be noted that the type (identification data) of the parameter data whose setting is to be changed using the data of the channel 5 (CH 5) and the channel 6 (CH 6) should be predetermined, for example, as Para 1.

FIG. 8, which is a table data stored in the parameter setting device 2 according to the third embodiment, is a corresponding data showing relationship between combination of each of both switches SW-A, B and the characteristics data, wherein each state of the upper, middle, and lower of the switch SW-A and each state of the upper, middle, and lower of the switch SW-B is combined to configure a matrix, and the characteristic data (9 data of 1100 to 1888) of the parameter data for each of the meshes is designated. The corresponding data requires to be input in advance from the input unit 11 to the parameter setting device 2.

In FIG. 5A, 5B, the condition data of the switch SW-A is stored in the channel 5 (CH 5) in the control signal A sent from the transmitter 1 to the parameter setting device 2 among the waveform shown in FIG. 3, and the channel 6 CH 6) stores the condition data of the switch SW-B. When the parameter setting device 2 receives the steering signal A, the setting control unit 14 of the parameter setting device 2 confirms the data of the channel 5 (CH 5) and channel 6 (CH 6) of the steering signal A. Since the fact that the channel 5 (CH 5) corresponds to the switch SW-A and the channel 6 (CH 6) corresponds to the switch SW-B is a matter preset in the setting control unit 14 of the parameter setting device 2, the setting control unit 14 can read from the data of the channel 5 (CH 5) that the state of the switch SW-A is at any one of the upper, middle, or lower, and from the data of the channel 6 (CH 6) the state of the switch SW-B is at any one of the upper, middle, and lower. Then, using the state of the read SW-A (one of the upper, lower, middle and lower) and the state of the SW-B (one of upper, lower, middle), and by referring to the corresponding data shown, the setting control unit 14 can acquire the type and value of the parameter data. For example, when both the data of the channel 5 (CH 5) and the data of the channel 6 (CH 6) are 1100 and both the switches SW-A and B-1 are in the upper state, the type (identification data) is Para 1, and its value (characteristic data) is 1888 from the corresponding data shown in FIG. 8.

The setting control unit 14 of the parameter setting device 2 sets the channel 7 of the steering signal shown in FIG. 3 (CH 7), the obtained identification data of the parameter data is stored, the characteristic data of the acquired parameter data is stored in the channel 8 (CH 8), and as shown in FIG. 5A, 5B, this is transmitted from the parameter setting device 2 to the transmitter 1 as the steering signal B. The subsequent operation is substantially the same as the second embodiment.

As described above, according to the communication system of the third embodiment, by combination of the condition data of a plurality of switches acquired as the channel data, the specific value with respect to the characteristic data of the specific parameter data can be selected from the more options than the second embodiment and can be transmitted to the transmitter 1. Therefore, as in the second embodiment, the types of numerical values that can be set are more expanded and the degree of freedom of parameter setting is higher than in the case that two switches are selectively selected by one switch.

Further, a flight condition changeover switch of the transmitter 1 can be used as a switch on the side of the transmitter 1 for changing the setting of the parameter data. The flight condition change-over switch is a switch for pitch curve, throttle curve, D/R, EXP adjustment, etc., which adjusts parameters for changing the operating feeling of the transmitter 1 side. If the switch is used, it becomes possible to change setting of parameter data to be operated in conjunction with a parameter changing operating feeling on the transmitter 1 side.

In each of the above-described embodiments, a gyro is exemplified as a target for changing setting of parameter data. However, as described above, it is also possible to set and change the parameter data of the servo motor by connecting a necessary number of control lines. Examples of parameters that can be changed in setting in this case include, for example, a boost amount for setting the minimum operation amount to be applied to the internal motor when driving the servo, a damping gain for setting the characteristic when the servo is stopped, a servo holding characteristic A stretcher gain for setting the motion of the servo, and smoother which is a function for smoothing the movement of the servo.

When the parameter data setting is to be changed in ESC, examples of parameters that can be changed in the ESC include forward boost for setting the rising characteristic on the forward side from neutral, setting of the output current limit value, a brake max duty for setting the brake strength between the maximum brake point and the neutral position, and a neutral brake for setting the neutral brake amount.

### DESCRIPTION OF SYMBOLS

1 transmitter
2 Parameter setting device
5 operation stick as operator
6, 7 switch as operator
11 input unit of parameter setting device
14 setting control unit of parameter setting device
15, 15a, 15b input unit as an operator
16 first control unit of the transmitter
22 second control unit of the receiver
25 body to be steered
30 gyro as operation object
31, 32 servomotor as operation object

What is claimed is:

1. A parameter setting device connected to a transmitter provided corresponding to a plurality of operation objects mounted on a body to be steered and repeatedly transmitting one frame of a steering signal having a plurality of channels, each of the channels having a control data of the operation object stored therein, and setting a parameter data to the operation object, the parameter setting device comprising:
an input unit inputting the parameter data; and
a setting control unit transmitting to the transmitter a setting signal in which the parameter data of a specific operation object is stored in a predetermined channel.

2. A parameter setting device connected to a transmitter provided corresponding to a plurality of operation objects mounted on a body to be steered and repeatedly transmitting one frame of a steering signal having a plurality of channels, each of the channels having a control data of the operation object stored therein, and setting a parameter data to the operation object, the parameter setting device comprising:
an input unit inputting the parameter data; and
a setting control unit storing in an empty channel the parameter data of a specific operation object in the steering signal of one frame received from the transmitter, and sending it to the transmitter.

3. The parameter setting device according to claim 2, wherein the setting control unit stores in a first empty channel an identification data as the parameter data in the steering signal of one frame received from the transmitter, and in a second empty channel a characteristic data as the parameter data.

4. The parameter setting device according to claim 2, wherein the transmitter includes a plurality of specific operators assigned to each of the specific channels, stores a condition data of a specific operator in a specific channel assigned to the specific operator, and sends the one frame of the steering signal to the parameter setting device, and wherein
the setting control unit handles the parameter data and a corresponding data indicating a relationship with the parameter data and the condition data of the specific operator, and obtains the parameter data of the specific operation object based on the corresponding data and the condition data of the specific operator included in the one frame of the steering signal received.

5. The parameter setting device according to claim 3, wherein
the transmitter includes a plurality of specific operators assigned to each of the specific channels, stores a condition data of a specific operator in a specific channel assigned to the specific operator, and sends the one frame of the steering signal to the parameter setting device, and wherein
the setting control unit handles the parameter data and a corresponding data indicating a relationship with the parameter data and the condition data of the specific operator, and obtains the parameter data of the specific operation object based on the corresponding data and the condition data of the specific operator included in the one frame of the steering signal received.
